(19) United States
(12) Patent Application Publication
(10) Pub. No.: US 2017/0359819 A1
(43) Pub. Date: Dec. 14, 2017

(54) Neighborhood Awareness Network and Multi-Channel Operation over OFDMA

(71) Applicant: MEDIATEK INC., Hsinchu (TW)

(72) Inventors: Chao-Chun Wang, Taipei City (TW); Chih-Shi Yee, Hsinchu City (TW); I-Cheng Tsai, Hsinchu County (TW)

(21) Appl. No.: 15/410,232

(22) Filed: Jan. 19, 2017

Related U.S. Application Data
(60) Provisional application No. 62/280,148, filed on Jan. 19, 2016.

(51) Int. Cl. H04W 72/04; H04L 5/00; H04W 76/02

(52) U.S. Cl. CPC H04W 72/0446; H04W 76/023; H04W 72/042; H04L 5/0007

(57) ABSTRACT

Apparatus and methods are provided for peer-to-peer communication network and multi-channel operation over OFDMA. In novel aspect, the communication device sends a first frame to reserve a time period for one or more peer-to-peer services in a wireless communication network, establishes one or more sessions with one or more peer-to-peer communication devices in the time period reserved for a subset of the one or more peer-to-peer services, transmits a second frame allocating radio resource for a subset of communications devices of the one or more communications devices, and sends or receives one or more data frames to/from one or more peer-to-peer communication devices concurrently using OFDMA, wherein the one or more data frames are received during the reserved time period. In one embodiment, the communication device is non-AP. In another embodiment, the second frame indicates resource blocks allocated for each of the one or more peer-to-peer communication devices.

### CROSS REFERENCE TO RELATED APPLICATIONS

This application claims priority under 35 U.S.C. §119 U.S. provisional application 62/280,148 entitled “NEIGHBORHOOD AWARENESS NETWORK AND MULTI-CHANNEL OPERATION OVER OFDMA” filed on Jan. 19, 2016, the subject matter of which is incorporated herein by reference.

### TECHNICAL FIELD

The disclosed embodiments relate generally to wireless communication, and, more particularly, to methods and apparatus for neighborhood awareness network and multi-channel operation over OFDMA.

### BACKGROUND

Wireless communication network has grown exponentially. In a traditional wireless network, each communication device connects to a fixed access point (AP). With the growing number of communication devices and growing number of applications on each device, the peer-to-peer wireless network is developed. In a peer-to-peer wireless network, the communications devices communicates with each other without setting up connectivity sessions with the fixed access point. Connections between peer communication devices can form one or more clusters such that each peer-to-peer connected devices can communicate with each other directly. Neighbor awareness network (NAN) for Wi-Fi is used for peer-to-peer communication. Multiple communication devices can exchange data without establishing connection sessions with the fixed wireless APs.

Orthogonal Frequency Division Multiplexing (OFDM) and Orthogonal Frequency Division Multiple Access (OFDMA) are both wideband digital communication technologies that are widely used in the wireless communication system. OFDMA is the multi-user OFDM technology where users can be assigned on both TDMA and FDMA basis where a single user does not necessarily need to occupy all the sub-carriers at any given time. In the current wireless standard, some already support the OFDMA. With OFDMA, it allows simultaneous low data rate transmission from several users as well as it can be dynamically assigned to the best non-fading, low interference channels for a particular user and avoid bad sub-carriers to be assigned.

In the peer-to-peer network, OFDM is used. Therefore, one to one communication or broadcast communication is supported. However, one to multiple-point connection is not available for the peer-to-peer communications.

Improvements and enhancements are required for neighborhood awareness network and multi-channel operation over OFDMA.

### SUMMARY

Apparatus and methods are provided for peer-to-peer communication network and multi-channel operation over OFDMA. In novel aspect, the communication device sends a first frame to reserve a time period for one or more peer-to-peer services in a wireless communication network, establishes one or more sessions with one or more peer-to-peer communication devices in the time period reserved for a subset of the one or more peer-to-peer services, transmits a second frame allocating radio resource for a subset of communications devices of the one or more communications devices, and sends or receives one or more data frames to/from one or more peer-to-peer communication devices concurrently using OFDMA, wherein the one or more data frames are received during the reserved time period. In one embodiment, the communication device is a non-AP or soft AP communication device. In another embodiment, the second frame indicates one or more resource blocks allocated for each of the one or more peer-to-peer communication devices. In another embodiment, the second frame further includes power control information for each of the one or more peer-to-peer communication devices. In yet another embodiment, the first frame is a request to send (RTS)/clear to send (CTS) frame. In one embodiment, the peer-to-peer wireless network is a neighbor awareness network (NAN) Wi-Fi network.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a peer-to-peer wireless network 100 with multiple communication devices.

FIG. 2 shows an exemplary block diagram of a communication device operating in a peer-to-peer communication network with OFDAM in accordance with embodiments of the current invention.

FIG. 3 illustrates an exemplary diagram of the resource allocation for multiple communication devices in the peer-to-peer networking using OFDMA in accordance with embodiments of the current invention.

FIG. 4 illustrates an exemplary diagram of the communication devices in a peer-to-peer network sending and/or receiving data frames to/from multiple peer-to-peer communication devices using OFDMA using reserved time period in accordance with embodiments of the current invention.

FIG. 5 illustrates an exemplary diagram for the NAN-wireless bridging (NWB) for the peer-to-peer network using OFDMA in accordance with embodiments of the current invention.

FIG. 6 illustrates an exemplary flow diagram for the NWB operation to set up OFDMA operation for the discovery window in accordance with embodiments of the current invention.

FIG. 7 illustrates an exemplary flow chart for a communication device to receive multiple data frames concurrently in a peer-to-peer communication network using OFDMA in accordance with embodiments of the current invention.

FIG. 8 illustrates an exemplary flow chart for a communication device to send multiple data frames concurrently in a peer-to-peer communication network using OFDMA in accordance with embodiments of the current invention.

### DETAILED DESCRIPTION

Reference will now be made in detail to some embodiments of the invention, examples of which are illustrated in the accompanying drawings.

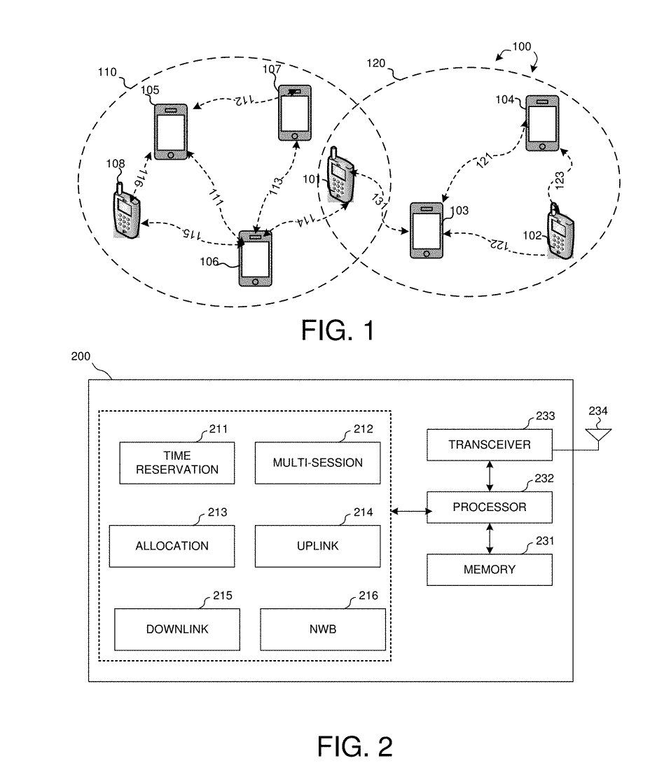

FIG. 1 illustrates a system diagram of a peer-to-peer wireless network 100 with multiple communication devices. Peer-to-peer wireless network 100 includes multiple communication devices, 101, 102, 103, 104, 105, 106, 107, and 108. In peer-to-peer wireless communications network 100, communication devices can communication with each other directly. For example, as shown in FIG. 1, communication device 105 communicates with communication devices 106, 107, and 108 through links 111, 112, and 116, respectively. Communicate device 106 further communicates with communication devices 101, 107, and 108 through links 114, 113, and 115, respectively. Similarly, communication device 102 communicates with communication devices 103, and 104 through links 122, and 123, respectively. Communication device 103 further communicates with communication devices 104 and 101 through links 121, and 131, respectively. It is understood by one of ordinary skills in the art that the combination of the communication links is exemplary. Any other combination are supported if all communicate requirements are met.

In one embodiment, NAN is a Wi-Fi peer-to-peer communication network. A NAN network comprises all NAN devices that share a common set of NAN parameters that include the time period between consecutive Discovery Windows (DW), the time duration of the DW, the beacon interval and NAN channels. A NAN device is a communication device that supports the NAN. For a NAN topology, one or more NAN clusters are formed. A NAN cluster is a collection of NAN devices that share a common set of NAN parameters and are synchronized to the same time window schedule. For example, wireless network 100 has two NAN clusters, cluster 110, and cluster 120. The NAN clusters can be completely separated or can be overlapped. Cluster 110 includes devices 101, 105, 106, 107, and 108. Cluster 120 includes devices 101, 102, 103, and 104. In this example, clusters 110 and 120 are overlapped. Communication device 101 belongs to both clusters 110 and 120. The communication device at any time can be covered in one or more clusters.

In one embodiment, a communication device in the peer-to-peer network can transmit different data to different peer communication devices concurrently. For example, communication device 101 communicates with communication devices 103 and 106. Communication device 101 can send different data frames to communication devices 106 and 103. In another embodiment, different data frames are received different communication devices concurrently using OFDMA.

FIG. 2 shows an exemplary block diagram of a communication device operating in a peer-to-peer communication network with OFDAM in accordance with embodiments of the current invention. Communication device 200 includes an antenna 234, a transceiver 233, a processor 232, and a memory 231. Communication device also includes a timer reservation circuit 211, a multi-session circuit, an uplink circuit, a downlink circuit 2214, and a NAN and high efficient (wireless) bridge circuit 215. Communication device 200 also includes transceiver module 233, coupled with antenna 234, receives RF signals from antenna 234, converts them to baseband signals and sends them to processor 232. Transceiver 233 also converts received baseband signals from the processor 232, converts them to RF signals, and sends out to antenna 234. Processor 232 processes the received baseband signals and invokes different functional modules to perform features in communication device 200. Memory 231 stores program instructions and data to control the operations of communication device 200.

Communication device 200 also includes functional modules 211, 212, 213, 214, 215, and 216 which carry out embodiments of the present invention. A time reservation circuit 211 sends a first frame to reserve a time period for one or more peer-to-peer services in a wireless communication network. A multi-session circuit 212 establishes one or more sessions with one or more peer-to-peer communication devices in the time period reserved for the one or more peer-to-peer services, wherein the one or more devices belong to a peer-to-peer communication network. An allocation circuit 213 transmits a second frame allocating radio resource for a subset of communications devices of the one or more communications devices. An uplink circuit 214 receives one or more data frames to one or more peer-to-peer communication devices concurrently using OFDMA, wherein the one or more data frames are received during the reserved time period. A downlink circuit 215 transmits one or more data frames to one or more peer-to-peer communication devices concurrently using OFDMA, wherein the one or more data frames are received during the reserved time period. A NAN high efficient (wireless) bridge (NWB) circuit 216 processes the schedule information from both the NAN and wireless interfaces and relays the information from one interface to another.

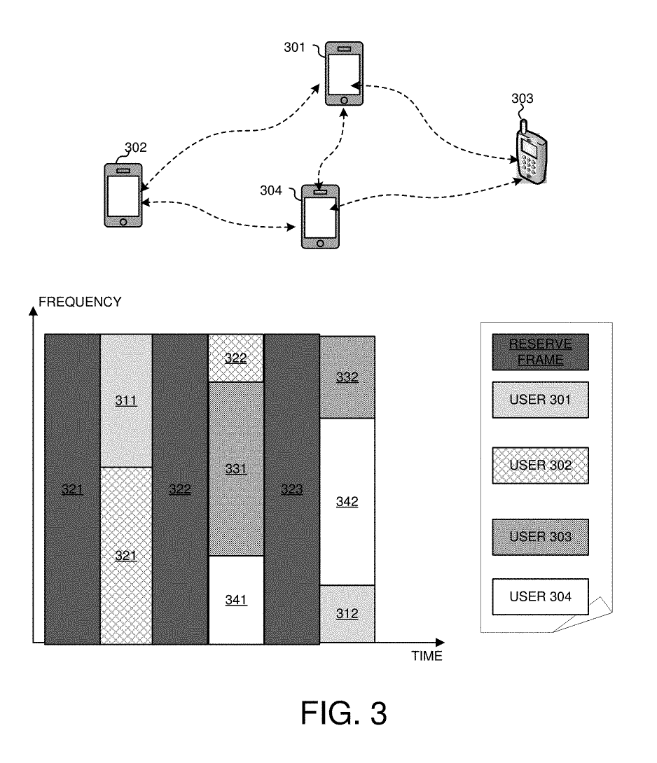

FIG. 3 illustrates an exemplary diagram of the resource allocation for multiple communication devices in the peer-to-peer networking using OFDMA in accordance with embodiments of the current invention. Communication devices 301, 302, 303, and 304 communicate with each other in a peer-to-peer network using OFDMA. In one embodiment, communication devices 301, 302, 303, and 304 are OFDMA enabled devices. With OFDMA, communication devices/users 301, 302, 303, 304 occupy a block of allocated resources for communications. The resource block for each of communication devices does not need to be consecutive. The resource block can be used to support multiple users concurrently. As an example, a time reservation frame 321 is sent to set a quiet period. Subsequently, resource blocks 311 for user 301 and 321 for 302 are sent. A time reservation frame 322 is sent to set a quiet period. Subsequently, resource block 322 for user 302, 331 for user 303, and 341 for user 304 are sent. A time reservation frame 323 is sent to set a quiet period. Subsequently, resource block 332 for user 303, 342 for user 304, and 312 for user 301 are sent. As shown, user/communication device 301 uses resource blocks 311 and 312; user/communication device 302 uses resource blocks 321 and 322; user/communication device 303 uses resource blocks 331 and 332; user/communication device 304 uses resource blocks 341 and 342. In one embodiment, the peer-to-peer network is a NAN Wi-Fi network. In a NAN network, a NAN device obeys CCA rule before transmitting frames in pre-determined/negotiated time windows. In particular, the NAN synchronization protocol defines a Discovery Windows sixteen TU long and appears every 512 ms. The NAN data link protocol further defines a set of service window (further availability resource blocks) negotiated between service providers and subscriber. In one embodiment, OFDMA is used in both the Discovery Window of NAN and Service Window of NAN. The synchronization and service discovery beacons are sent in OFDMA mode. In another embodiment, multiple set of NAN services, such as NAN services for communication devices 301, 302, 303, and 304, operate in service windows using OFDMA mode.

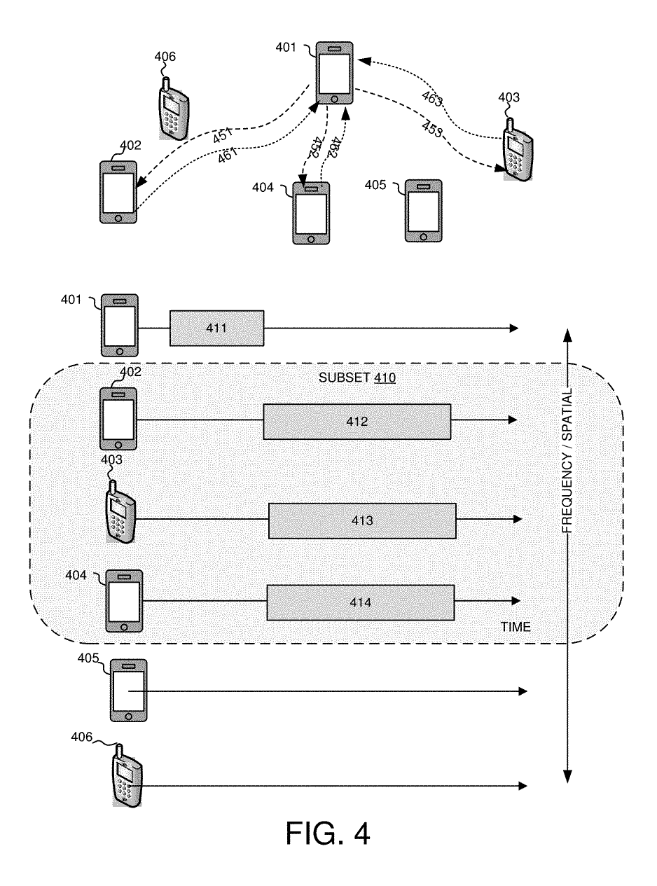

FIG. 4 illustrates an exemplary diagram of the communication devices in a peer-to-peer network sending and/or receiving data frames to/from multiple peer-to-peer communication devices using OFDMA using reserved time period in accordance with embodiments of the current invention. Communication devices 401, 402, 403, 404, 405, and 406 communicate with each other in the peer-to-peer network. In one novel aspect, one to more multi-cast is supported for the peer-to-peer network using OFDMA. In one embodiment, as shown, communication device 401 receives concurrently uplink data frames from a subset of the one or more communication devices 402, 403, and 404 using OFDMA via uplink 461, 462, and 463, respectively. The uplink data frames from different communication devices 402, 403, and 404, use pre-allocated radio resources. The contents of uplink data packets from different peer-to-peer communication devices can be different. For example, communication device 401 receives data frames concurrently from a subset of communication devices 402, 403, and 404, each of which can send different contents to communication device 401. In another embodiment, as shown, communication device 401 sends downlink data frames to one or more peer-to-peer communication devices using OFDMA via downlink 451, 452, and 453, respectively. The downlink data frames use pre-allocated radio resources. The contents of data packets can be different for different receiving communication devices. For example, communication device 401 sends multicast data frames concurrently to communication devices 402, 403, and 404. The data frames include different contents to communication device 402, 403, and 404.

In order to support multiple communication sessions using OFDMA in the peer-to-peer network, the communication device makes a time reservation for other peer-to-peer communication devices. As shown, communication device 401 sends a data frame 411 to reserve a time period for communication devices 402, 403, and 404. In one embodiment, the time reserved is used by one or more peer-to-peer communication devices to send data frames concurrently to one communication device in the peer-to-peer communication network. As shown, multiple peer-to-peer sessions 412, 413, and 414 are created for communication devices 402, 403, and 403, respectively. Communication devices 402, 403, and 403 send data frames to communication devices 401 using the resource blocks in the OFMDA. In another embodiment, the time reserved is used by one or more peer-to-peer communication devices to receive data frames concurrently from one multicast communication device. As shown, multiple peer-to-peer sessions 412, 413, and 414 are created for communication devices 402, 403, and 403, respectively. Communication devices 402, 403, and 403 receive data frames from communication device 401 using the resource blocks in the OFMDA.

In one embodiment, the data frame sent by communication device 401 to reserve a time period indicates one or more resource blocks allocated for each of the one or more peer-to-peer communication devices. In another embodiment, the management frame sent by communication device 401 to reserve a time period further includes power control information for each of the one or more peer-to-peer communication devices. In yet another embodiment, request to send (RTS)/clear to send (CTS) frame is used to reserve a time period for the one or more peer-to-peer communication devices.

A NAN device obeys CCA rule before transmitting frames in pre-determined/negotiated time windows. The NAN synchronization protocol defines a Discovery Windows. The NAN data link protocol further defines a set of service window (further availability resource blocks) negotiated between service providers and subscribers. NAN devices operate in pre-determined/negotiated windows. The timing of the discovery or service window is determined between a set of NAN devices. Thus, there is potentially increased contention and inefficiency due to lack of coordination between NAN scheduled operations and the 802.11 communications network operations. By utilizing OFDMA, certain NAN data operations can be supported more efficiently. Facilitating NAN device to operate in OFDMA mode will benefit both NAN operation and channel utilization of Wi-Fi BSSs. To enable NAN devices to operate in OFDMA mode in Discovery Window and Service Window, the system will send Synchronization and service discovery beacons in OFDMA mode. Multiple set of NAN services operate in service windows using OFDMA mode.

In one novel aspect, a NAN-Wireless bridging (NWB) layer is proposed for a dual role communication device to create the NWB above the NAN and wireless MAC/PHY interfaces. The layer processes the schedule information from both interfaces and relays the information from one interface to another.

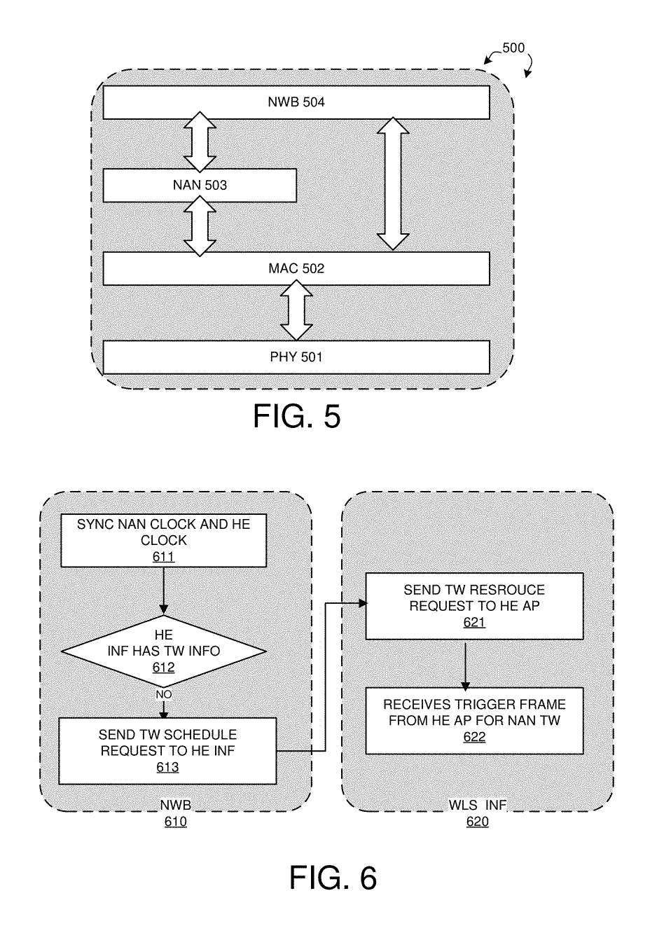

FIG. 5 illustrates an exemplary diagram for the NAN-Wireless bridging (NWB) for the peer-to-peer network using OFDMA in accordance with embodiments of the current invention. A communication device 500 is a wireless and NAN dual role device. A NAN cluster covers the range of several 802.11ax BBSs. A wireless device follows the 802.11ax protocol. Communication device 500 has a PHY layer 501 and MAC layer 502. In one embodiment, PHY layer 501 and MAC layer 502 follows the 802.11ax protocol. Communication device 500 has a NAN layer 503 communicates with MAC layer 502. NAN layer 503 handles NAN protocol processing and further communicates with a NBH layer. A NBH layer with NAN 503 and MAC 502, processes the schedule information from NAN layer 503 and MAC layer 502 interfaces and relays the information from one interface to another communicates.

FIG. 6 illustrates an exemplary flow diagram for the NWB operation to set up OFDMA operation for the discovery window in accordance with embodiments of the current invention. During an initial phase, NAN cluster master creates a cluster in the SU mode. The NAN cluster master subsequently sends first synchronization beacons in a time window and sets up OFDMA operation for the DW. At step 611, a NBH layer 610 syncs internally the NAN clock and the wireless clock. At step 612, NBH layer 610 checks if the wireless interface has the time window schedule information. If step 612 determines no, NBH layer 610 sends a time window schedule request to the wireless interface. Subsequently, at step 621, the wireless interface 620 upon receiving the time window schedule request from NBH 610, a time window resource request frame to the wireless AP to reserve time period. The purpose of the time period is for wireless stations to avoid time window of NAN operation. At step 622, wireless interface 620 receives trigger frame for quiet time period before every NAN DW. In one embodiment, the default resource allocation of OFDMA operation is based on NAN ID or any other methods. In one embodiment, NAN master devices send synchronization beacons in the time window using OFDMA mode. NAN devices belonging to different wireless APs follow the same operation.

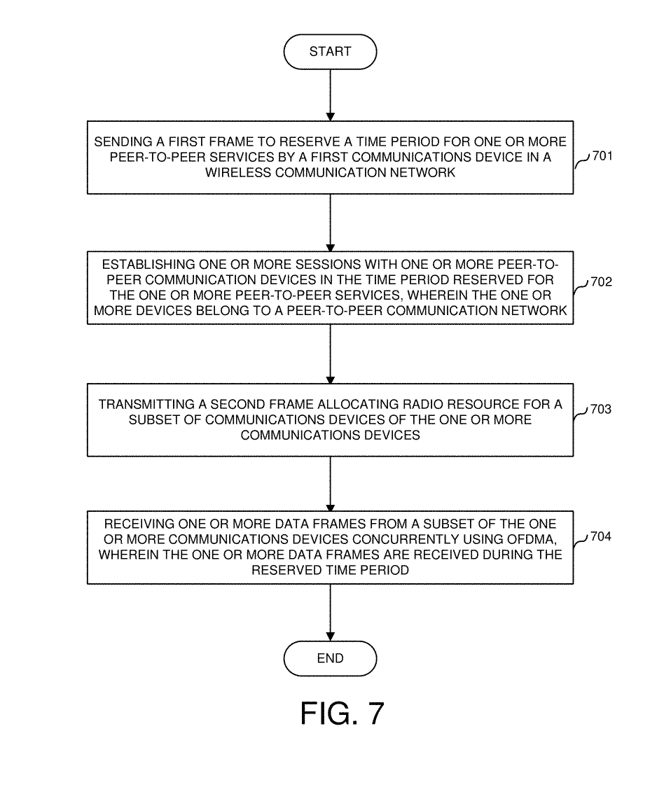

FIG. 7 illustrates an exemplary flow chart for a communication device to receive multiple data frames concurrently in a peer-to-peer communication network using OFDMA in accordance with embodiments of the current invention. At step 701, the communication device sends a first frame to reserve a time period for one or more peer-to-peer services in a wireless communication network. At step 702, the communication device establishes one or more sessions with one or more peer-to-peer communication devices in the time period reserved for the one or more peer-to-peer services, wherein the one or more devices belong to a peer-to-peer communication network. At step 703, the communication device transmits a second frame allocating radio resource for a subset of communications devices of the one or more communications devices. At step 704, the communication device receives one or more data frames from a subset of the one or more communications devices concurrently using OFDMA, wherein the one or more data frames are received during the reserved time period.

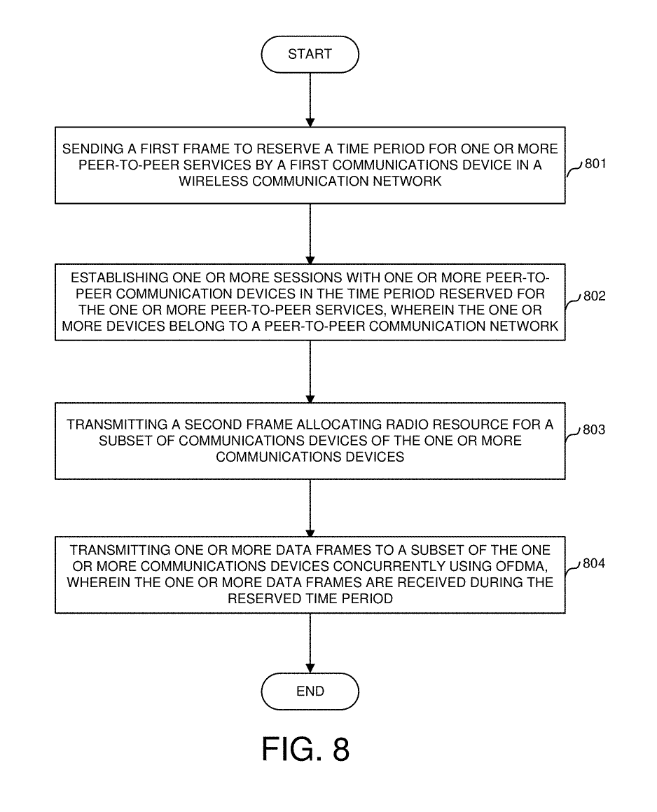

FIG. 8 illustrates an exemplary flow chart for a communication device to send multiple data frames concurrently in a peer-to-peer communication network using OFDMA in accordance with embodiments of the current invention. At step 801, the communication device sends a first frame to reserve a time period for one or more peer-to-peer services in a wireless communication network. At step 802, the communication device establishes one or more sessions with one or more peer-to-peer communication devices in the time period reserved for the one or more peer-to-peer services, wherein the one or more devices belong to a peer-to-peer communication network. At step 803, the communication device transmits a second frame allocating radio resource for a subset of communications devices of the one or more communications devices. At step 804, the communication device transmits one or more data frames to a subset of the one or more communications devices concurrently using OFDMA, wherein the one or more data frames are received during the reserved time period.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
sending a first frame to reserve a time period for one or more peer-to-peer services by a first communications device in a wireless communication network;
establishing one or more sessions with one or more peer-to-peer communication devices in the time period reserved for the one or more peer-to-peer services, wherein the one or more devices belong to a peer-to-peer communication network;
transmitting a second frame allocating radio resource for a subset of communications devices of the one or more communications devices; and
receiving one or more data frames from a subset of the one or more communications devices concurrently using OFDMA, wherein the one or more data frames are received during the reserved time period.

2. The method of claim 1, wherein the first communications device is a non-AP device in the peer-to-peer wireless communication network.

3. The method of claim 1, wherein the first communication is a soft-AP device.

4. The method of claim 1, wherein the second frame indicates one or more resource blocks allocated for each of the one or more peer-to-peer communication devices.

5. The method of claim 4, wherein the second frame further includes power control information for each communication device of the subset of the one or more peer-to-peer communication devices.

6. The method of claim 1, wherein the first frame is a request to send (RTS)/clear to send (CTS) frame.

7. The method of claim 1, wherein the first frame is a management frame to reserve a time period for the one or more communications device.

8. The method of claim 1, wherein the peer-to-peer wireless network is a neighbor awareness network (NAN) Wi-Fi network.

9. A method comprising:
sending a first frame to reserve a time period for one or more peer-to-peer services by a first communications device in a wireless communication network;
establishing one or more sessions with one or more peer-to-peer communication devices in the time period reserved for the one or more peer-to-peer services, wherein the one or more devices belong to a peer-to-peer communication network;
transmitting a second frame allocating radio resource for a subset of communications devices of the one or more communications devices; and
transmitting one or more data frames to a subset of the one or more communications devices concurrently using OFDMA, wherein the one or more data frames are received during the reserved time period.

10. The method of claim 9, wherein the first communications device is a non-AP device in the peer-to-peer wireless communication network.

11. The method of claim 9, wherein the second frame indicates one or more resource blocks allocated for each of the one or more peer-to-peer communication devices.

12. The method of claim 11, wherein the second frame further includes power control information for each communication device of the subset of the one or more peer-to-peer communication devices.

13. The method of claim 9, wherein the first frame is a management frame to reserve a time period for the one or more communications device.

14. The method of claim 9, wherein the peer-to-peer wireless network is a neighbor awareness network (NAN) Wi-Fi network.

15. A communication device, comprising:
a radio frequency (RF) transceiver that transmits and receives radio signals in a wireless communication network;
a time reservation circuit that sends a first frame to reserve a time period for one or more peer-to-peer services in a wireless communication network;
a multi-session circuit that establishes one or more sessions with one or more peer-to-peer communication devices in the time period reserved for the one or more peer-to-peer services, wherein the one or more devices belong to a peer-to-peer communication network;
an allocation circuit that transmits a second frame allocating radio resource for a subset of communications devices of the one or more communications devices; and
an uplink circuit that receives one or more data frames from a subset of the one or more communications devices concurrently using OFDMA, wherein the one or more data frames are received during the reserved time period.

16. The communication device of claim 15, wherein the second frame indicates one or more resource blocks allocated for each of the one or more peer-to-peer communication devices.

17. The communication device of claim 16, wherein the second frame further includes power control information for each communication device of the subset of the one or more peer-to-peer communication devices.

18. The communication device of claim 15, wherein the first frame is a management frame to reserve a time period for the one or more communications device.

19. The communication device of claim 15, wherein the first frame is a request to send (RTS)/clear to send (CTS) frame

20. The communication device of claim 15, wherein the peer-to-peer wireless network is a neighbor awareness network (NAN) Wi-Fi network.

21. The communication device of claim 15, further comprising: a downlink circuit that transmits one or more data frames to a subset of the one or more communications devices concurrently using OFDMA, wherein the one or more data frames are received during the reserved time period.
